(19) United States
(12) Patent Application Publication
(10) Pub. No.: US 2026/0237787 A1
(43) Pub. Date: Aug. 13, 2026

(54) COOLANT PASSAGE PLATES FOR A BATTERY CELL ASSEMBLY

(71) Applicant: GM Global Technology Operations LLC, Detroit, MI (US)

(72) Inventors: Zhenwen Hu, Shanghai (CN); Oliver Rene Rudwinsky, Oakland, MI (US); Jian Yao, Shanghai (CN); Chengwu Duan, Shanghai (CN); Lu Huang, Troy, MI (US); Hui-ping Wang, Troy, MI (US)

(21) Appl. No.: 19/036,685

(22) Filed: Jan. 24, 2025

(30) Foreign Application Priority Data
Jan. 20, 2025 (CN) 202510089010.5

(51) Int. Cl. H01M 10/6557; H01M 10/613; H01M 10/625; H01M 10/647; H01M 10/653; H01M 50/209; H01M 50/249

(52) U.S. Cl. CPC H01M 10/6557; H01M 10/613; H01M 10/625; H01M 10/647; H01M 10/653; H01M 50/209; H01M 50/249

(57) ABSTRACT

A superbeam assembly for a battery cell assembly includes a left coolant passage plate including a left section defining a left stamped channel section, a right section defining a right stamped channel section, a left inner channel surface, and a left outer channel surface. The superbeam assembly includes a right coolant passage plate including a right section defining a right stamped channel section, a right section defining a right stamped channel section, a right inner channel surface, and a right outer channel surface. A channel profile defined by the left stamped channel section of the left coolant passage plate is a mirror image of the right stamped channel section of the right coolant passage plate and a channel profile defined by the right stamped channel section of the left coolant passage plate is a mirror image of the left stamped channel section of the right coolant passage plate.

### INTRODUCTION

The present disclosure relates to coolant passage plates that are part of a superbeam assembly for a battery cell assembly.

Rechargeable energy storage system (RESS) may be used in a variety of applications. For example, a vehicle may include a rechargeable battery pack to power one or more electric motors that provide motive power to the vehicle. It is to be appreciated that temperature is a significant factor that may impact performance of a battery pack. As an example, thermal runaway propagation (TRP) refers to a situation where the temperature of an individual battery cell increases rapidly and thereby causes the temperature of an adjacent battery cell to also increase rapidly. Accordingly, rechargeable battery packs may be provided with individual cooling passage plates to maintain an appropriate temperature of the battery pack.

Furthermore, it is also to be appreciated that as battery cells charge and discharge they expand and contract. Aerogels and other types of elastic or compliant materials may be used to facilitate transverse pre-compression as well as accommodate transverse expansion of the battery cells during charging and discharging cycles. A superbeam assembly refers to an integrated solution that combines structural support beams with cooling channels in a single, integrated structure. Existing superbeam assemblies include a left coolant plate and a right coolant plate, where a one set of tooling is required to create the left coolant plate while a separate set of tooling is required to create the right coolant plate. Moreover, existing superbeam assemblies may also only provide a limited amount of transverse expansion as well.

Thus, while existing battery packs achieve their intended purpose, there is a need in the art for improved coolant passage plates that are simple to manufacture and accommodate thermal expansion.

### SUMMARY

According to several aspects, a superbeam assembly for a battery cell assembly is disclosed. The superbeam assembly includes a left coolant passage plate including a left section defining a left stamped channel section, a right section defining a right stamped channel section, a left inner channel surface, and a left outer channel surface. The super beam assembly also includes a right coolant passage plate including a right section defining a right stamped channel section, a right section defining a right stamped channel section, a right inner channel surface, and a right outer channel surface. The left inner channel surface defined by the left coolant passage plate faces the right inner channel surface of the right coolant passage plate. A channel profile defined by the left stamped channel section of the left coolant passage plate is a mirror image of the right stamped channel section of the right coolant passage plate and a channel profile defined by the right stamped channel section of the left coolant passage plate is a mirror image of the left stamped channel section of the right coolant passage plate.

In another aspect, a clearance is measured between the left inner channel surface of the left coolant passage plate and the right inner channel surface of the right coolant passage plate, and the clearance ranges from about 0.5 millimeters to about 4 millimeters.

In yet another aspect, the left outer channel surface of the left coolant passage plate and the right outer channel surface of the right coolant passage plate are coated with a filler metal.

In an aspect, the left stamped channel section of the left coolant passage plate defines a left serpentine profile including a plurality of vertically oriented sections, and each vertically oriented section of the left serpentine profile of left stamped channel section of the left section of the left coolant passage plate includes a vertical height.

In another aspect, the right stamped channel section of the left coolant passage plate defines a right serpentine profile including a plurality of vertically oriented sections, and where a vertical space is positioned between each vertically oriented section of the right serpentine profile of the right stamped channel section of the right section of the left coolant passage plate.

In yet another aspect, the vertical height of the vertically oriented sections of the left serpentine profile is equal to the vertical space positioned between each vertically oriented section of the right serpentine profile of the left coolant passage plate.

In an aspect, the left stamped channel section of the right coolant passage plate includes a left serpentine profile defining a plurality of vertically oriented sections, and where a vertical space is positioned between each vertically oriented section of the left serpentine profile of the left stamped channel section of the left section of the right coolant passage plate.

In another aspect, the right stamped channel section of the right coolant passage plate includes a right serpentine profile defining a plurality of vertically oriented sections, where each vertically oriented section of the right serpentine profile of the right stamped channel section of the right section of the right coolant passage plate includes a vertical height.

In yet another aspect, the vertical space of the vertically oriented sections of the left serpentine profile of the left stamped channel section of the left section of the right coolant passage plate is equal to the vertical height positioned between each vertically oriented section of the right serpentine profile of the right stamped channel section of the right section of the right coolant passage plate.

In an aspect, the superbeam assembly further comprises a left face plate joined to the left coolant passage plate and a right face plate joined to the right coolant passage plate.

In another aspect, the left stamped channel section of the left section of the left coolant passage plate cooperates with an inner surface of the left face plate to create a left-hand side channel and the left stamped channel section of the left section of the right coolant passage plate cooperates with an inner surface of the right face plate to create a right-hand side channel.

In yet another aspect, the superbeam assembly further comprises a spacer disposed between the inner surface of the left face plate and the inner surface of the right face plate.

In an aspect, the left stamped channel section of the left coolant passage plate defines a left serpentine profile including a plurality of vertically oriented sections, and where each vertically oriented section of the left stamped channel section of the left coolant passage plate includes a vertical height.

In another aspect, the right stamped channel section of the left coolant passage plate defines a right serpentine profile including a plurality of vertically oriented sections, and where each vertically oriented section of the right serpentine profile of the right stamped channel section of the right section of the left coolant passage plate includes a vertical height that is equal to the vertical height of the vertically oriented sections of the left serpentine profile of the left stamped channel section of the left section of the left coolant passage plate.

In yet another aspect, an uppermost vertically oriented section of the left serpentine profile of the left stamped channel section of the left section of the left coolant passage plate and an uppermost vertically oriented section of the right serpentine profile of the right stamped channel section of the right section of the left coolant passage plate are both positioned at a distance from an upper edge of the left coolant passage plate.

In an aspect, a lowermost vertically oriented section of the left serpentine profile of the left stamped channel section of the left section of the left coolant passage plate and a lowermost vertically oriented section of the right serpentine profile of the right stamped channel section of the right section of the left coolant passage plate are both positioned at the distance plus an offset distance from a lower edge of the left coolant passage plate.

In another aspect, the left coolant passage plate and the right coolant passage plate both define a coolant inlet opening and a coolant outlet opening, and wherein a pair of connection rings that are coated with a filler metal provide sealing to the coolant inlet opening and the coolant outlet opening of both the left coolant passage plate and the right coolant passage plate.

In yet another aspect, a battery cell assembly for a battery pack that is part of a vehicle includes at least two pairs of opposing battery cells, where each pair of opposing battery cells includes a left-hand side battery cell and a right-hand side battery cell, and a superbeam assembly. The superbeam assembly includes a pair of face plates disposed between each pair of opposing battery cells, where the pair of face plates include a left face plate and a right face plate. The superbeam assembly also includes a left coolant passage plate including a left section defining a left stamped channel section, a right section defining a right stamped channel section, a left inner channel surface, and a left outer channel surface, where the left face plate is joined to the left coolant passage plate. The superbeam assembly also includes a right coolant passage plate including a right section defining a right stamped channel section, a right section defining a right stamped channel section, a right inner channel surface, and a right outer channel surface, wherein the left inner channel surface defined by the left coolant passage plate faces the right inner channel surface of the right coolant passage plate and the right face plate is joined to the right coolant passage plate, and where a channel profile defined by the left stamped channel section of the left coolant passage plate is a mirror image of the right stamped channel section of the right coolant passage plate and a channel profile defined by the right stamped channel section of the left coolant passage plate is a mirror image of the left stamped channel section of the right coolant passage plate.

In another aspect, the battery cell assembly is a prismatic battery cell.

In yet another aspect, a battery cell assembly for a battery pack that is part of a vehicle includes at least two pairs of opposing battery cells, wherein each pair of opposing battery cells includes a left-hand side battery cell and a right-hand side battery cell, and a superbeam assembly. The superbeam assembly includes a pair of face plates disposed between each pair of opposing battery cells, where the pair of face plates include a left face plate and a right face plate. The superbeam assembly includes a left coolant passage plate including a left section defining a left stamped channel section, a right section defining a right stamped channel section, a left inner channel surface, and a left outer channel surface, wherein the left face plate is joined to the left coolant passage plate. The superbeam assembly also includes a right coolant passage plate including a right section defining a right stamped channel section, a right section defining a right stamped channel section, a right inner channel surface, and a right outer channel surface. The left inner channel surface defined by the left coolant passage plate faces the right inner channel surface of the right coolant passage plate and the right face plate is joined to the right coolant passage plate, and wherein a channel profile defined by the left stamped channel section of the left coolant passage plate is a mirror image of the right stamped channel section of the right coolant passage plate and a channel profile defined by the right stamped channel section of the left coolant passage plate is a mirror image of the left stamped channel section of the right coolant passage plate, and a clearance ranging from about 0.5 millimeters to about 4 millimeters is measured between the left inner channel surface of the left coolant passage plate and the right inner channel surface of the right coolant passage plate.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle including a battery pack having a plurality of battery cell assemblies, according to an exemplary embodiment;

FIG. 2 is an elevated perspective view of one of the battery cell assemblies shown in FIG. 1, according to an exemplary embodiment;

FIG. 3A is a cross-sectioned view of a superbeam assembly that is part of the battery cell assembly taken along section line A-A in FIG. 2, according to an exemplary embodiment;

FIG. 3B illustrates a top portion of an alternative embodiment of the superbeam assembly including a clip disposed on the top of two face plates that are part of the superbeam assembly, according to an exemplary embodiment;

FIG. 4A is a front view of an outer channel surface of a left coolant passage plate that is part of the superbeam assembly shown in FIG. 3A, according to an exemplary embodiment;

FIG. 4B is a front view of an outer channel surface of a right coolant passage plate that is part of the superbeam assembly shown in FIG. 3A, according to an exemplary embodiment;

FIG. 5A is a front view of an outer channel surface of an alternative embodiment of the left coolant passage plate that is part of the superbeam assembly, according to an exemplary embodiment;

FIG. 5B is a front view of an outer channel surface of an alternative embodiment of a right coolant passage plate that is part of the superbeam assembly, according to an exemplary embodiment; and

FIG. 6 is an assembly view of the superbeam assembly prior to being joined together by a brazing process.

### DETAILED DESCRIPTION

The following description is merely exemplary in nature and is not intended to limit the present disclosure, application, or uses.

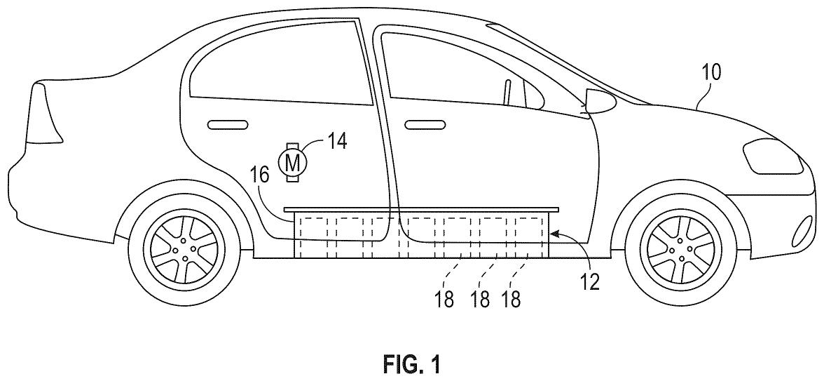

Referring to FIG. 1, a schematic diagram of a vehicle 10 including an exemplary battery pack 12 for providing power to one or more electric motors 14 is illustrated. It is to be appreciated that although the vehicle 10 is illustrated as a sedan, the vehicle 10 may be any other type of vehicle such as, but not limited to, a truck, sport utility vehicle, van, or motor home. The battery pack 12 includes a battery enclosure 16 that contains a plurality of battery cell assemblies 18 that are electrically connected to one another. Although a vehicle 10 is described and illustrated in FIG. 1, it is to be appreciated that the battery pack 12 is not limited to a vehicle and may be employed in other rechargeable energy storage system (RESS) applications as well.

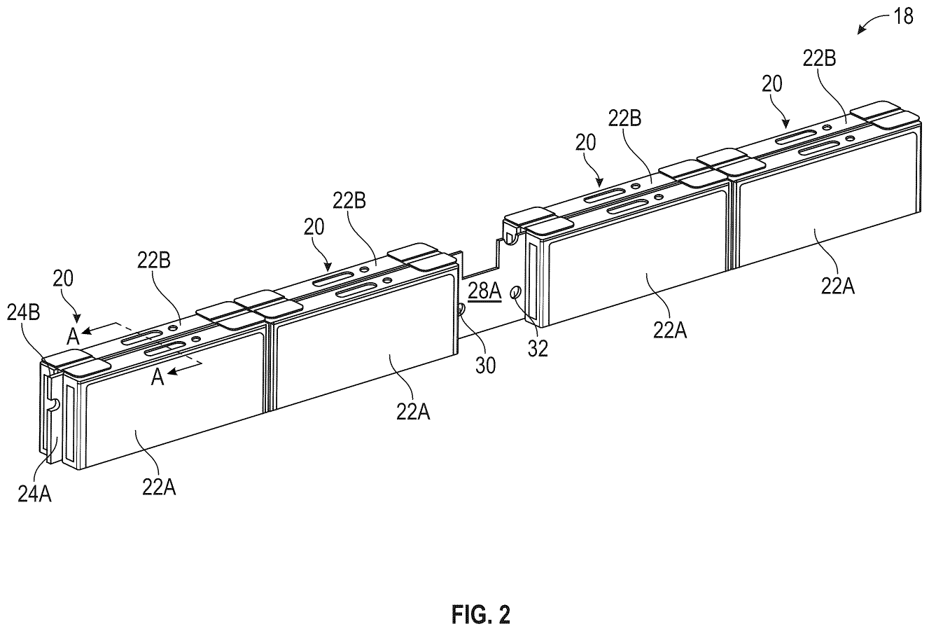

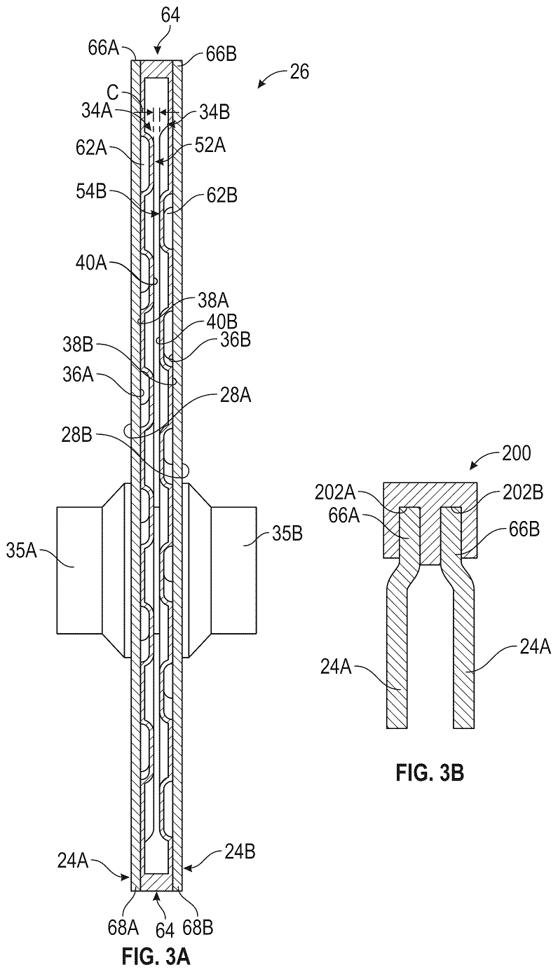

FIG. 2 is an elevated perspective view of one of the battery cell assemblies 18 shown in FIG. 1. It is to be appreciated that the battery cell assembly 18 is a prismatic battery cell. The battery cell assembly 18 includes at least two pairs 20 of opposing battery cells 22A, 22B, where each pair 20 of opposing battery cells 22A, 22B includes a left-hand side battery cell 22A and a right-hand side battery cell 22B. In the non-limiting embodiment as shown in FIG. 2, the battery cell assembly 18 includes four pairs 20 of opposing battery cells 22A, 22B. A superbeam assembly 26 including a pair of face plates 24A, 24B is disposed between each pair 20 of opposing battery cells 22A 22B of the battery cell assembly 18. Specifically, referring to FIGS. 2 and 3A, the pair of face plates include a left face plate 24A defining an outer surface 28A that faces the at least two left-hand side battery cells 22A and a right face plate 24B (visible in FIG. 3A) defining an outer surface 28B that faces the at least two right-hand side battery cells 22B.

As seen in FIG. 2, both the left face plate 24A and the right face plate 24B both include a planar profile and define a coolant inlet opening 30 and a coolant outlet opening 32 (the coolant inlet opening 30 and the coolant outlet opening 32 are only visible in FIG. 2 for the left face plate 24A). Coolant may enter the superbeam assembly 26 via the respective coolant inlet openings 30 within the face plates 24A, 24B and exit the superbeam assembly 26 via the coolant outlet openings 32 within the face plates 24A, 24B.

The outer surface 28A of the left face plate 24A of the superbeam assembly 26 is in thermal contact with and draws heat from the left-hand side battery cells 22A and the outer surface 28B (seen in FIG. 3A) of the right face plate 24B of the superbeam assembly 26 is in thermal contact with and draws heat from the right-hand side battery cells 22B. In embodiments, a thermal interface material (not visible in FIG. 2) may be disposed between the left face plate 24A and the left-hand side battery cells 22A as well as the right face plate 24B and the right-hand side battery cells 22B. The thermal interface material is a thermally conductive material that acts as an adhesive to secure the face plates 24A, 24B to the respective battery cells 22A, 22B.

FIG. 3A is a cross-sectioned view of the superbeam assembly 26 shown in FIG. 2 taken along section line A-A, where the battery cells 22A, 22B have been omitted. The superbeam assembly 26 includes the left face plate 24A, the right face plate 24B, a left coolant passage plate 34A joined to the left face plate 24A, a right coolant passage plate 34B that is joined to the right face plate 24B, a pair of left spigots 35A (only one spigot 35A is visible in FIG. 3A) joined to the outer surface 28A of the left face plate 24A, and a pair of right spigots 35B (only one spigot 35B is visible in FIG. 3A) joined to the outer surface 28B of the right face plate 24B. Specifically, the left face plate 24A defines the outer surface 28A that faces the left-hand side battery cells 22A (FIG. 2) and an inner surface 36A that is joined to a left outer channel surface 38A of the left coolant passage plate 34A. Similarly, the right face plate 24B defines the outer surface 28B that faces the right-hand side battery cells 22B and an inner surface 36B that is joined to a right outer channel surface 38B of the right coolant passage plate 34B.

It is to be appreciated that the left face plate 24A is joined to the left coolant passage plate 34A and the right face plate 24B is joined to the right coolant passage plate 34B by a joining approach such as, for example, brazing or laser welding. Specifically, in an embodiment where brazing is employed, the left outer channel surface 38A of the left coolant passage plate 34A may be coated with a filler metal before being joined to the inner surface 36A of the left face plate 24A by placing the superbeam assembly 26 in an oven for brazing. Similarly, the right outer channel surface 38B of the right coolant passage plate 34B may be coated with a filler metal before being joined to the inner surface 36B of the right face plate 24B before placing the superbeam assembly 26 in an oven for brazing.

The left coolant passage plate 34A defines the left outer channel surface 38A that is joined to the inner surface 36A of the left face plate 24A and a left inner channel surface 40A. Similarly, the right coolant passage plate 34B defines the right outer channel surface 38B that is joined to the inner surface 36B of the right face plate 24B and a right inner channel surface 40B. As seen in FIG. 3A, the left inner channel surface 40A of the left coolant passage plate 34A faces the right inner channel surface 40B of the right coolant passage plate 34B.

A clearance C is measured between the left inner channel surface 40A of the left coolant passage plate 34A and the right inner channel surface 40B of the right coolant passage plate 34B. The clearance C represents an air gap between the left coolant passage plate 34A and the right coolant passage plate 34B. It is to be appreciated that the clearance C between the left coolant passage plate 34A and the right coolant passage plate 34B provide transverse elastic compliance to the superbeam assembly 26 in the transverse or y-direction. That is, the clearance C is sized to accommodate sideways compression of the battery cell assembly 18 in the y-direction. In one non-limiting embodiment, the size of the clearance C ranges from about 0.5 millimeters to about 4 millimeters, however, it is to be appreciated that other dimensions may be used as well.

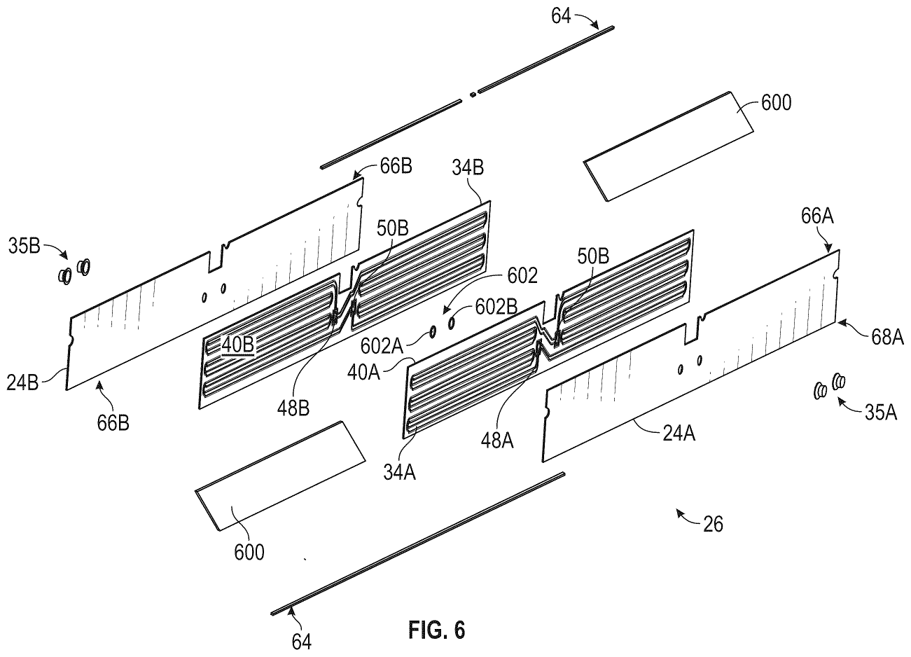

It is to be appreciated that when brazing is employed to join the left outer channel surface 38A of the left coolant passage plate 34A with the inner surface 36A of the left face plate 24A and the right outer channel surface 38B of the right coolant passage plate 34B with the inner surface 36B of the right face plate 24B, sheets 600 (shown in FIG. 6) that are constructed of heat-resistant material such as mica or steel may be inserted between the left inner channel surface 40A of the left coolant passage plate 34A and the right inner channel surface 40B of the right coolant passage plate 34B to maintain the clearance C, and are removed after brazing. Merely by way of example, in the embodiment as shown in FIG. 6, two sheets 600 that each have a thickness ranging from about 0.5 to about 2 millimeters may be inserted between the left inner channel surface 40A of the left coolant passage plate 34A and the right inner channel surface 40B of the right coolant passage plate 34B.

In the embodiment as shown in FIG. 3A, a spacer 64 is positioned on a top portion 66A, 66B and a bottom portion 68A, 68B of the face plates 24A, 24B. Specifically, the spacer 64 is disposed between the inner surface 36A of the left face plate 24A and the inner surface 36B of the right face plate 24B and acts as a stopper to maintain the clearance C between the left inner channel surface 40A of the left coolant passage plate 34A and the right inner channel surface 40B of the right coolant passage plate 34B.

FIG. 3B illustrates an alternative embodiment of the top portion 66A, 66B of the face plates 24A, 24B, where a clip 200 is used instead of a spacer 64 to maintain the clearance C between the left inner channel surface 40A of the left coolant passage plate 34A and the right inner channel surface 40B of the right coolant passage plate 34B. The clip 200 may include a left opening 202A that is shaped to receive the top portion 66A of the left face plate 24A and a right opening 202B that is shaped to receive the top portion 66B of the right face plate 24B.

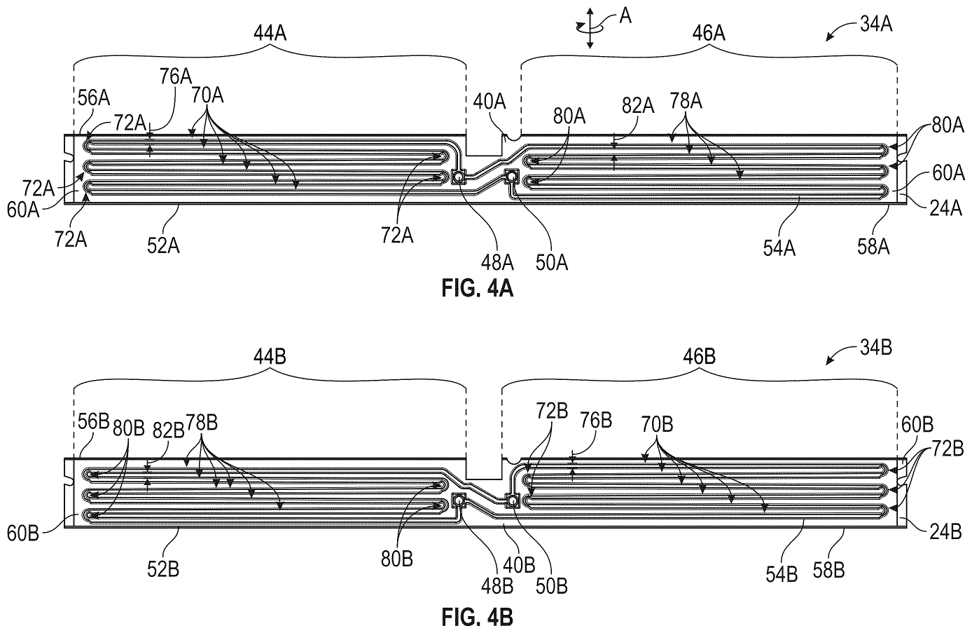

FIG. 4A illustrates the left inner channel surface 40A of the left coolant passage plate 34A and FIG. 4B illustrates the right inner channel surface 40B of the right coolant passage plate 34B. Both the left coolant passage plate 34A and the right coolant passage plate 34B include a planar profile. Referring to FIGS. 3A and 4A, the left coolant passage plate 34A defines a left section 44A, a right section 46A, a coolant inlet opening 48A that corresponds to the coolant inlet opening 30 of the left face plate 24A (FIG. 2), a coolant outlet opening 50A that corresponds to the coolant outlet opening 32 of the left face plate 24A, an upper edge 56A, a lower edge 58A, and opposing side edges 60A. The left section 44A of the left coolant passage plate 34A defines a left stamped channel section 52A that includes a left serpentine profile and is fluidly connected to both the coolant inlet opening 48A and the coolant outlet opening 50A. Similarly, the right section 46A of the left coolant passage plate 34A defines a right stamped channel section 54A that includes a right serpentine profile and is fluidly connected to both the coolant inlet opening 48A and the coolant outlet opening 50A.

Referring specifically to FIGS. 3A and 4A, the left stamped channel section 52A of the left section 44A of the left coolant passage plate 34A represents a raised section of the left inner channel surface 40A of the left coolant passage plate 34A. As seen in FIG. 3A, the left stamped channel section 52A of the left section 44A of the left coolant passage plate 34A cooperates with the inner surface 36A of the left face plate 24A to create a left-hand side channel 62A. Similarly, the right stamped channel section 54A of the right section 46A of the left coolant passage plate 34A represents a raised section of the left inner channel surface 40A of the left coolant passage plate 34A. The right stamped channel section 54A of the right section 46A of the left coolant passage plate 34A cooperates with the inner surface 36B of the right face plate 24B to create a right-hand side channel (not visible in the figures).

The coolant inlet opening 48A and the coolant outlet opening 50A are disposed in between the left stamped channel section 52A of the left section 44A and the right stamped channel section 54A of the right section 46A of the left coolant passage plate 34A. In the embodiment as shown in FIG. 4A, both the coolant inlet opening 48A and the coolant outlet opening 50A of the left coolant passage plate 34A are positioned at the same height when measured from either the upper edge 56A or the lower edge 58A of the left coolant passage plate 34A. However, it is to be appreciated that the coolant inlet opening 48A and the coolant outlet opening 50A may be positioned at different heights relative to the upper edge 56A or the lower edge 58A of the left coolant passage plate 34A as well.

Referring to FIGS. 3A and 4B, the right coolant passage plate 34B defines a left section 44B, a right section 46B, a coolant inlet opening 48B that corresponds to the coolant inlet opening 30 of the left face plate 24A (FIG. 2), a coolant outlet opening 50B that corresponds to the coolant outlet opening 32 of the right face plate 24B, an upper edge 56B, a lower edge 58B, and opposing side edges 60B. The left section 44B of the right coolant passage plate 34B defines a left stamped channel section 52B that includes a left serpentine profile and is fluidly connected to both the coolant inlet opening 48B and the coolant outlet opening 50B. Similarly, the right section 46B of the right coolant passage plate 34B defines a right stamped channel section 54B that includes a right serpentine profile and is fluidly connected to both the coolant inlet opening 48B and the coolant outlet opening 50B.

The left stamped channel section 52B of the left section 44B of the right coolant passage plate 34B represents a raised section of the right inner channel surface 40B of the right coolant passage plate 34B. As seen in FIG. 3A, the left stamped channel section 52B of the left section 44B of the right coolant passage plate 34B cooperates with the inner surface 36B of the right face plate 24B to create a right-hand side channel 62B. Similarly, the right stamped channel section 54B of the right section 46B of the right coolant passage plate 34B represents a raised section of the right inner channel surface 40B of the right coolant passage plate 34B. The right stamped channel section 54B of the right section 46B of the right coolant passage plate 34B cooperates with the inner surface 36B of the right face plate 24B to create a right-hand side channel (not visible in the figures).

The coolant inlet opening 48B and the coolant outlet opening 50B are disposed in between the left stamped channel section 52B of the left section 44B and the right stamped channel section 54B of the right section 46B of the right coolant passage plate 34B. In the non-limiting embodiment as shown in FIG. 4B, both the coolant inlet opening 48B and the coolant outlet opening 50B of the right coolant passage plate 34B are positioned at the same height when measured from either the upper edge 56B or the lower edge 58B of the right coolant passage plate 34B.

Referring to FIG. 4A, the left serpentine profile of the left stamped channel section 52A of the left section 44A of the left coolant passage plate 34A defines a plurality of vertically oriented sections 70A that are connected to one another by a plurality of 180 degree or half-rotation turns 72A. The vertically oriented sections 70A of the left serpentine profile of the left stamped channel section 52A of the left section 44A of the left coolant passage plate 34A are each spaced equidistant with respect to one another, where each vertically oriented section 70A includes a vertical height 76A.

The right serpentine profile of the right stamped channel section 54A of the right section 46A of the left coolant passage plate 34A defines a plurality of vertically oriented sections 78A that are connected to one another by a plurality of 180 degree or half-rotation turns 80A. The vertically oriented sections 78A of the right serpentine profile of the right stamped channel section 54A of the right section 46A of the left coolant passage plate 34A are each spaced equidistant with respect to one another. A vertical space 82A is positioned between each vertically oriented section 78A of the right serpentine profile of the right stamped channel section 54A of the right section 46A of the left coolant passage plate 34A.

It is to be appreciated that the vertical height 76A of the vertically oriented sections 70A of the left serpentine profile of the left stamped channel section 52A of the left section 44A of the left coolant passage plate 34A is equal to the vertical space 82A positioned between each vertically oriented section 78A of the right serpentine profile of the right stamped channel section 54A of the right section 46A of the left coolant passage plate 34A. In other words, the left stamped channel sections 52B of the left section 44B of the left coolant passage plate 34A, which represent a raised section of the left inner channel surface 40A of the left coolant passage plate 34A, include the same height as the vertical spaces 82A positioned between the right stamped channel sections 54A of the right section 46A of the left coolant passage plate 34A.

Referring to FIG. 4B, the left serpentine profile of the left stamped channel section 52B of the left section 44B of the right coolant passage plate 34B defines a plurality of vertically oriented sections 78B that are connected to one another by a plurality of 180 degree or half-rotation turns 80B. The vertically oriented sections 78B of the left serpentine profile of the left stamped channel section 52B of the left section 44B of the right coolant passage plate 34B are each spaced equidistant with respect to one another. A vertical space 82B is positioned between each vertically oriented section 78B of the left serpentine profile of the left stamped channel section 52B of the left section 44B of the right coolant passage plate 34B.

The right serpentine profile of the right stamped channel section 54B of the right section 46B of the right coolant passage plate 34B defines a plurality of vertically oriented sections 70B that are connected to one another by a plurality of 180 degree or half-rotation turns 72B. The vertically oriented sections 70B of the right serpentine profile of the right stamped channel section 54B of the right section 46B of the right coolant passage plate 34B are each spaced equidistant with respect to one another, where each vertically oriented section 70B includes a vertical height 76B.

It is to be appreciated that the vertical space 82B of the vertically oriented sections 78B of the left serpentine profile of the left stamped channel section 52B of the left section 44B of the right coolant passage plate 34B is equal to the vertical height 76B positioned between each vertically oriented section 70B of the right serpentine profile of the right stamped channel section 54B of the right section 46B of the right coolant passage plate 34B. In other words, the right stamped channel sections 54B of the right section 46B of the right coolant passage plate 34B, which represent a raised section of the right inner channel surface 40B of the right coolant passage plate 34B, include the same height as the vertical spaces 82B positioned between the left stamped channel sections 52B of the left section 44B of the right coolant passage plate 34B.

It is to be appreciated that a die or tool that is used to form the left stamped channel section 52A and the right stamped channel section 54A the left coolant passage plate 34A (the tool is not shown) may be rotated 180 degrees about a vertical axis A (shown in FIG. 4A) and is then used to form the left stamped channel section 52B and the right stamped channel section 54B of the right coolant passage plate 34B. In other words, a channel profile defined by the left stamped channel section 52A of the left coolant passage plate 34A is a mirror image of the right stamped channel section 54B of the right coolant passage plate 34B. Similarly, a channel profile defined by the right stamped channel section 54A of the left coolant passage plate 34A is a mirror image of the left stamped channel section 52B of the right coolant passage plate 34B.

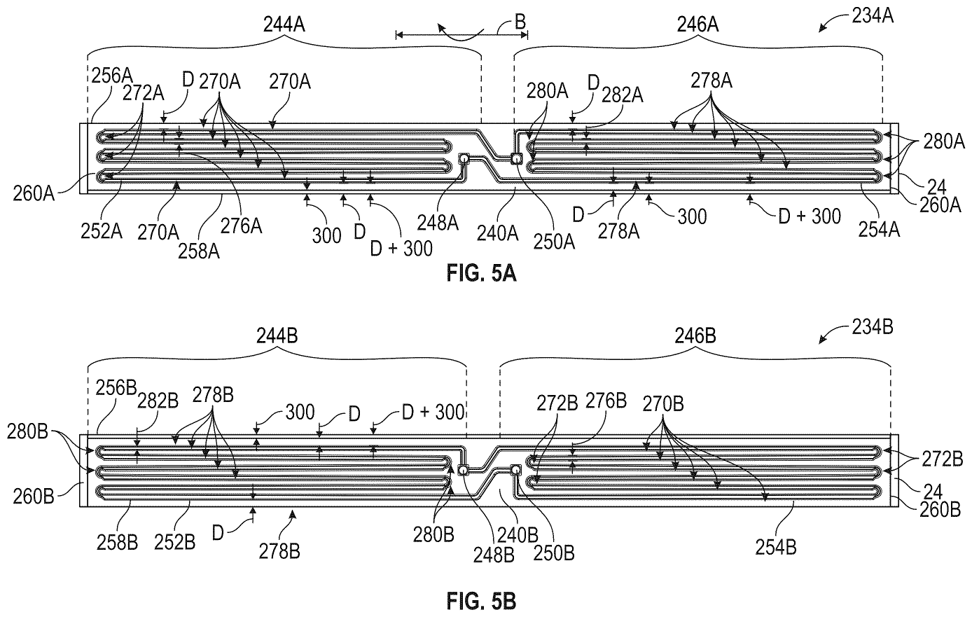

FIG. 5A illustrates an alternative embodiment of the left inner channel surface 240A of the left coolant passage plate 234A and FIG. 5B illustrates an alternative embodiment of the right inner channel surface 240B of the right coolant passage plate 234B. Referring to FIG. 5A, the left coolant passage plate 234A defines a left section 244A, a right section 246A, a coolant inlet opening 248A that corresponds to the coolant inlet opening 30 of the left face plate 24A (FIG. 2), a coolant outlet opening 250A that corresponds to the coolant outlet opening 32 of the left face plate 24A, an upper edge 256A, a lower edge 258A, and opposing side edges 260A. The left section 244A of the left coolant passage plate 234A defines a left stamped channel section 252A that includes a left serpentine profile and is fluidly connected to both the coolant inlet opening 248A and the coolant outlet opening 250A. Similarly, the right section 246A of the left coolant passage plate 234A defines a right stamped channel section 254A that includes a right serpentine profile and is fluidly connected to both the coolant inlet opening 248A and the coolant outlet opening 250A.

The left stamped channel section 252A of the left section 244A of the left coolant passage plate 234A cooperates with the inner surface 36A of the left face plate 24A (FIG. 3A) to create a left-hand side channel (not shown in the figures). Similarly, the right stamped channel section 254A of the right section 246A of the left coolant passage plate 234A represents a raised section of the left inner channel surface 240A of the left coolant passage plate 234A. The right stamped channel section 254A of the right section 246A of the left coolant passage plate 234A cooperates with the inner surface 36B of the right face plate 24B (shown in FIG. 3A) to create a right-hand side channel (not visible in the figures).

The coolant inlet opening 248A and the coolant outlet opening 250A are disposed in between the left stamped channel section 252A of the left section 244A and the right stamped channel section 254A of the right section 246A of the left coolant passage plate 234A. In the embodiment as shown in FIG. 5A, both the coolant inlet opening 248A and the coolant outlet opening 250A of the left coolant passage plate 234A are positioned at the same height when measured from either the upper edge 256A or the lower edge 258A of the left coolant passage plate 234A.

Referring to FIG. 5B, the right coolant passage plate 234B defines a left section 244B, a right section 246B, a coolant inlet opening 248B that corresponds to the coolant inlet opening 30 of the left face plate 24A (FIG. 2), a coolant outlet opening 250B that corresponds to the coolant outlet opening 32 of the right face plate 24B, an upper edge 256B, a lower edge 258B, and opposing side edges 260B. The left section 244B of the right coolant passage plate 234B defines a left stamped channel section 252B that includes a left serpentine profile and is fluidly connected to both the coolant inlet opening 248B and the coolant outlet opening 250B. Similarly, the right section 246B of the right coolant passage plate 234B defines a right stamped channel section 254B that includes a right serpentine profile and is fluidly connected to both the coolant inlet opening 248B and the coolant outlet opening 250B.

The left stamped channel section 252B of the left section 244B of the right coolant passage plate 234B represents a raised section of the right inner channel surface 240B of the right coolant passage plate 234B. The left stamped channel section 252B of the left section 244B of the right coolant passage plate 234B cooperates with the inner surface 36B of the right face plate 24B (FIG. 3A) to create a right-hand side channel (not shown in the figures). Similarly, the right stamped channel section 254B of the right section 246B of the right coolant passage plate 234B represents a raised section of the right inner channel surface 240B of the right coolant passage plate 234B. The right stamped channel section 254B of the right section 246B of the right coolant passage plate 234B cooperates with the inner surface 36B of the right face plate 24B to create a right-hand side channel (not visible in the figures).

The coolant inlet opening 248B and the coolant outlet opening 250B are disposed in between the left stamped channel section 252B of the left section 244B and the right stamped channel section 254B of the right section 246B of the right coolant passage plate 234B. In the non-limiting embodiment as shown in FIG. 5B, both the coolant inlet opening 248B and the coolant outlet opening 250B of the right coolant passage plate 234B are positioned at the same height when measured from either the upper edge 256B or the lower edge 258B of the right coolant passage plate 234B.

Referring to FIG. 5A, the left serpentine profile of the left stamped channel section 252A of the left section 244A of the left coolant passage plate 234A defines a plurality of vertically oriented sections 270A that are connected to one another by a plurality of 180 degree or half-rotation turns 272A. The vertically oriented sections 270A of the left serpentine profile of the left stamped channel section 252A of the left section 244A of the left coolant passage plate 234A are each spaced equidistant with respect to one another, where each vertically oriented section 270B includes a vertical height 276A.

The right serpentine profile of the right stamped channel section 254A of the right section 246A of the left coolant passage plate 234A defines a plurality of vertically oriented sections 278A that are connected to one another by a plurality of 180 degree or half-rotation turns 280A. The vertically oriented sections 278A of the right serpentine profile of the right stamped channel section 254A of the right section 246A of the left coolant passage plate 234A are each spaced equidistant with respect to one another, where each vertically oriented section 278A of the right serpentine profile of the right stamped channel section 254A of the right section 246A of the left coolant passage plate 234A includes a vertical height 282A that is equal to the vertical height 276A of the vertically oriented sections 270A of the left serpentine profile of the left stamped channel section 252A of the left section 244A of the left coolant passage plate 234A.

As seen in FIG. 5A, an uppermost vertically oriented section 270A of the left serpentine profile of the left stamped channel section 252A of the left section 244A of the left coolant passage plate 234A and an uppermost vertically oriented section 278A of the right serpentine profile of the right stamped channel section 254A of the right section 246A of the left coolant passage plate are both positioned at a distance D from the upper edge 256A of the left coolant passage plate 234A. A lowermost vertically oriented section 270A of the left serpentine profile of the left stamped channel section 252A of the left section 244A of the left coolant passage plate 234A and a lowermost vertically oriented section 278A of the right serpentine profile of the right stamped channel section 254A of the right section 246A of the left coolant passage plate are both positioned at the distance D plus an offset distance 300 from the lower edge 258A of the left coolant passage plate 234A (i.e., D+300).

In an embodiment, the offset distance 300 is equal to one-half the vertical height 276A of the vertically oriented sections 270A of the left serpentine profile of the left stamped channel section 252A of the left section 244A of the left coolant passage plate 234A (which is the same as the vertical height 282A of the vertically oriented sections 278A of the right serpentine profile of the right stamped channel section 254A of the right section 246A of the left coolant passage plate 234A).

Referring to FIG. 5B, the left serpentine profile of the left stamped channel section 252B of the left section 244B of the right coolant passage plate 234B defines a plurality of vertically oriented sections 278B that are connected to one another by a plurality of 180 degree or half-rotation turns 280B. The vertically oriented sections 278B of the left serpentine profile of the left stamped channel section 252B of the left section 244B of the right coolant passage plate 234B are each spaced equidistant with respect to one another, where each vertically oriented section 278B includes a vertical height 282B.

The right serpentine profile of the right stamped channel section 254B of the right section 246B of the right coolant passage plate 234B defines a plurality of vertically oriented sections 270B that are connected to one another by a plurality of 180 degree or half-rotation turns 272B. The vertically oriented sections 270B of the left serpentine profile of the right stamped channel section 254B of the right section 246B of the right coolant passage plate 234B are each spaced equidistant with respect to one another, where each vertically oriented section 270B includes a vertical height 276B.

As seen in FIG. 5B, an uppermost vertically oriented section 278B of the left serpentine profile of the left stamped channel section 252B of the left section 244B of the right coolant passage plate 234B and an uppermost vertically oriented section 270B of the right serpentine profile of the right stamped channel section 254B of the right section 246A of the right coolant passage plate 234B are both positioned at the distance D plus the offset distance 300 from the upper edge 256B of the right coolant passage plate 234B. A lowermost vertically oriented section 278B of the left serpentine profile of the left stamped channel section 252B of the left section 244B of the right coolant passage plate 234B and a lowermost vertically oriented section 270B of the right serpentine profile of the right stamped channel section 254A of the right section 246A of the left coolant passage plate are both positioned at the distance D from the lower edge 258B of

### The Right Coolant Passage Plate 234b.

It is to be appreciated that a die or tool that is used to form the left stamped channel section 252A and the right stamped channel section 254A of the left coolant passage plate 234A (the tool is not shown) may be rotated 180 degrees about a horizontal axis B (shown in FIG. 5A) and is then used to form the left stamped channel section 252B and the right stamped channel section 254B of the right coolant passage plate 234B. It is to be appreciated that the channel profile defined by the left stamped channel section 252A of the left coolant passage plate 234A is a mirror image of the right stamped channel section 254B of the right coolant passage plate 234B. Similarly, the channel profile defined by the right stamped channel section 254A of the left coolant passage plate 234A is a mirror image of the left stamped channel section 252B of the right coolant passage plate 234B.

FIG. 6 is an assembly view of the superbeam assembly 26 prior to being joined together by a brazing process. As seen in FIG. 6, the superbeam assembly 26 includes the pair of face plates 24A, 24B, the left coolant passage plate 34A, the right coolant passage plate 34B, a spacer 64 corresponding to the top portion 66A, 66B of the face plates 24A, 24B, a spacer 64 corresponding to the bottom portion 68A, 68B of the face plates 24A, 24B, the pair of left spigots 35A, the pair of right spigots 35B, the two sheets 600 inserted between the left inner channel surface 40A of the left coolant passage plate 34A and the right inner channel surface 40B of the right coolant passage plate 34B, and a pair of connection rings 602.

The pair of connection rings 602 include an inlet connection ring 602A that provides sealing to the coolant inlet opening 48A of the left coolant passage plate 34A and the coolant inlet opening 48B of the right coolant passage plate 34B as well as an outlet connection ring 602B that provides sealing to the coolant outlet opening 50A of the left coolant passage plate 34A and the coolant outlet opening 50B of the right coolant passage plate 34B. The pair of connection rings 602 are placed between the left inner channel surface 40A of the left coolant passage plate 34A and the right inner channel surface 40B of the right coolant passage plate 34B and are coated with a filler metal prior to the brazing process.

Referring generally to the figures, the disclosed embodiments of the superbeam assembly provide various technical effects and benefits. Specifically, it is to be appreciated that a single tool may be used to form the left stamped channel section and the right stamped channel section for both the left and right coolant passage plates. It is also to be appreciated that the superbeam assembly includes a clearance, which represents an air gap, between the left coolant passage plate and the right coolant passage plate to accommodate sideways compression of the battery cell assembly. The disclosed superbeam assembly includes compression rigidity that is similar to a superbeam assembly constructed from aerogels.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A superbeam assembly for a battery cell assembly, comprising:
a left coolant passage plate including a left section defining a left stamped channel section, a right section defining a right stamped channel section, a left inner channel surface, and a left outer channel surface; and
a right coolant passage plate including a right section defining a right stamped channel section, a right section defining a right stamped channel section, a right inner channel surface, and a right outer channel surface, wherein the left inner channel surface defined by the left coolant passage plate faces the right inner channel surface of the right coolant passage plate, and wherein a channel profile defined by the left stamped channel section of the left coolant passage plate is a mirror image of the right stamped channel section of the right coolant passage plate and a channel profile defined by the right stamped channel section of the left coolant passage plate is a mirror image of the left stamped channel section of the right coolant passage plate.

2. The superbeam assembly of claim 1, wherein a clearance is measured between the left inner channel surface of the left coolant passage plate and the right inner channel surface of the right coolant passage plate, and wherein the clearance ranges from about 0.5 millimeters to about 4 millimeters.

3. The superbeam assembly of claim 1, wherein the left outer channel surface of the left coolant passage plate and the right outer channel surface of the right coolant passage plate are coated with a filler metal.

4. The superbeam assembly of claim 1, wherein the left stamped channel section of the left coolant passage plate defines a left serpentine profile including a plurality of vertically oriented sections, and wherein each vertically oriented section of the left serpentine profile of left stamped channel section of the left section of the left coolant passage plate includes a vertical height.

5. The superbeam assembly of claim 4, wherein the right stamped channel section of the left coolant passage plate defines a right serpentine profile including a plurality of vertically oriented sections, and wherein a vertical space is positioned between each vertically oriented section of the right serpentine profile of the right stamped channel section of the right section of the left coolant passage plate.

6. The superbeam assembly of claim 5, wherein the vertical height of the vertically oriented sections of the left serpentine profile is equal to the vertical space positioned between each vertically oriented section of the right serpentine profile of the left coolant passage plate.

7. The superbeam assembly of claim 1, wherein the left stamped channel section of the right coolant passage plate includes a left serpentine profile defining a plurality of vertically oriented sections, and wherein a vertical space is positioned between each vertically oriented section of the left serpentine profile of the left stamped channel section of the left section of the right coolant passage plate.

8. The superbeam assembly of claim 7, wherein the right stamped channel section of the right coolant passage plate includes a right serpentine profile defining a plurality of vertically oriented sections, wherein each vertically oriented section of the right serpentine profile of the right stamped channel section of the right section of the right coolant passage plate includes a vertical height.

9. The superbeam assembly of claim 8, wherein the vertical space of the vertically oriented sections of the left serpentine profile of the left stamped channel section of the left section of the right coolant passage plate is equal to the vertical height positioned between each vertically oriented section of the right serpentine profile of the right stamped channel section of the right section of the right coolant passage plate.

10. The superbeam assembly of claim 1, further comprising a left face plate joined to the left coolant passage plate and a right face plate joined to the right coolant passage plate.

11. The superbeam assembly of claim 10, wherein the left stamped channel section of the left section of the left coolant passage plate cooperates with an inner surface of the left face plate to create a left-hand side channel and the left stamped channel section of the left section of the right coolant passage plate cooperates with an inner surface of the right face plate to create a right-hand side channel.

12. The superbeam assembly of claim 11, further comprising a spacer disposed between the inner surface of the left face plate and the inner surface of the right face plate.

13. The superbeam assembly of claim 1, wherein the left stamped channel section of the left coolant passage plate defines a left serpentine profile including a plurality of vertically oriented sections, and wherein each vertically oriented section of the left stamped channel section of the left coolant passage plate includes a vertical height.

14. The superbeam assembly of claim 13, wherein the right stamped channel section of the left coolant passage plate defines a right serpentine profile including a plurality of vertically oriented sections, and wherein each vertically oriented section of the right serpentine profile of the right stamped channel section of the right section of the left coolant passage plate includes a vertical height that is equal to the vertical height of the vertically oriented sections of the left serpentine profile of the left stamped channel section of the left section of the left coolant passage plate.

15. The superbeam assembly of claim 14, wherein an uppermost vertically oriented section of the left serpentine profile of the left stamped channel section of the left section of the left coolant passage plate and an uppermost vertically oriented section of the right serpentine profile of the right stamped channel section of the right section of the left coolant passage plate are both positioned at a distance from an upper edge of the left coolant passage plate.

16. The superbeam assembly of claim 15, wherein a lowermost vertically oriented section of the left serpentine profile of the left stamped channel section of the left section of the left coolant passage plate and a lowermost vertically oriented section of the right serpentine profile of the right stamped channel section of the right section of the left coolant passage plate are both positioned at the distance plus an offset distance from a lower edge of the left coolant passage plate.

17. The superbeam assembly of claim 1, wherein the left coolant passage plate and the right coolant passage plate both define a coolant inlet opening and a coolant outlet opening, and wherein a pair of connection rings that are coated with a filler metal provide sealing to the coolant inlet opening and the coolant outlet opening of both the left coolant passage plate and the right coolant passage plate.

18. A battery cell assembly for a battery pack that is part of a vehicle, the battery cell assembly comprising:
at least two pairs of opposing battery cells, wherein each pair of opposing battery cells includes a left-hand side battery cell and a right-hand side battery cell; and
a superbeam assembly including:
a pair of face plates disposed between each pair of opposing battery cells, wherein the pair of face plates include a left face plate and a right face plate;
a left coolant passage plate including a left section defining a left stamped channel section, a right section defining a right stamped channel section, a left inner channel surface, and a left outer channel surface, wherein the left face plate is joined to the left coolant passage plate; and
a right coolant passage plate including a right section defining a right stamped channel section, a right section defining a right stamped channel section, a right inner channel surface, and a right outer channel surface, wherein the left inner channel surface defined by the left coolant passage plate faces the right inner channel surface of the right coolant passage plate and the right face plate is joined to the right coolant passage plate, and wherein a channel profile defined by the left stamped channel section of the left coolant passage plate is a mirror image of the right stamped channel section of the right coolant passage plate and a channel profile defined by the right stamped channel section of the left coolant passage plate is a mirror image of the left stamped channel section of the right coolant passage plate.

19. The battery cell assembly of claim 18, wherein the battery cell assembly is a prismatic battery cell.

20. A battery cell assembly for a battery pack that is part of a vehicle, the battery cell assembly comprising:
at least two pairs of opposing battery cells, wherein each pair of opposing battery cells includes a left-hand side battery cell and a right-hand side battery cell; and
a superbeam assembly including:
a pair of face plates disposed between each pair of opposing battery cells, wherein the pair of face plates include a left face plate and a right face plate;
a left coolant passage plate including a left section defining a left stamped channel section, a right section defining a right stamped channel section, a left inner channel surface, and a left outer channel surface, wherein the left face plate is joined to the left coolant passage plate; and
a right coolant passage plate including a right section defining a right stamped channel section, a right section defining a right stamped channel section, a right inner channel surface, and a right outer channel surface, wherein the left inner channel surface defined by the left coolant passage plate faces the right inner channel surface of the right coolant passage plate and the right face plate is joined to the right coolant passage plate, and wherein a channel profile defined by the left stamped channel section of the left coolant passage plate is a mirror image of the right stamped channel section of the right coolant passage plate and a channel profile defined by the right stamped channel section of the left coolant passage plate is a mirror image of the left stamped channel section of the right coolant passage plate, and wherein a clearance ranging from about 0.5 millimeters to about 4 millimeters is measured between the left inner channel surface of the left coolant passage plate and the right inner channel surface of the right coolant passage plate.
